(19) United States
(12) Patent Application Publication
(10) Pub. No.: US 2015/0019069 A1
(43) Pub. Date: Jan. 15, 2015

(54) REVERSE EVENT SIGNATURE FOR IDENTIFYING HIT AND RUN VEHICLES

(71) Applicant: International Business Machines Corporation, Armonk, NY (US)

(72) Inventors: Aaron K. Baughman, Silver Spring, MD (US); Wilfredo Ferre, Le Mesnil le Roi (FR); Peter K. Malkin, Yorktown Heights, NY (US); Marc P. Yvon, Antony (FR)

(73) Assignee: International Business Machines Corporation, Armonk, NY (US)

(21) Appl. No.: 13/970,114

(22) Filed: Aug. 19, 2013

Related U.S. Application Data
(63) Continuation of application No. 13/938,344, filed on Jul. 10, 2013.

(51) Int. Cl. G07C 5/00; G07C 5/08

(52) U.S. Cl. CPC G07C 5/008; G07C 5/08
USPC 701/32.2

(57) ABSTRACT

Identifying a vehicle involved in a hit-and-run accident may comprise generating a damage signature associated with a first vehicle that is left behind with collision damage in a hit-and-run accident. A reverse event signature may be generated that indicates a position of impact and severity of damage associated with a second vehicle involved in the hit-and-run accident that fled a scene of the hit-and-run accident. The generating of the reverse event signature may be based on reverse engineering the damage signature associated with the first vehicle.

### CROSS-REFERENCE TO RELATED APPLICATIONS

This application is a continuation of U.S. Ser. No. 13/938,344, filed on Jul. 10, 2013, the entire content and disclosure of which is incorporated herein by reference.

### FIELD

The present application relates generally to computers, and computer applications, and more particularly to a system for identifying and/or locating a vehicle, for example, involved in a hit and run accident.

### BACKGROUND

Generally, a vehicular hit-and-run refers to causing a traffic or vehicular accident and fleeing the scene of the accident without stopping to identify oneself. When a hit-and-run occurs, it is desirable to locate the vehicle that fled, for example, so that damages may be recovered. However, locating the vehicle is often difficult and no known system is established for quickly disseminating information to the public, for example, to body shops in order to locate the vehicle.

### BRIEF SUMMARY

A method for identifying a vehicle involved in a hit-and-run accident, in one aspect, may comprise generating a damage signature associated with a first vehicle that is left behind with collision damage in a hit-and-run accident. The method may also comprise generating a reverse event signature that indicates a position of impact and severity of damage associated with a second vehicle involved in the hit-and-run accident that fled a scene of the hit-and-run accident, the generating of the reverse event signature based on reverse engineering the damage signature associated with the first vehicle.

A system for identifying a vehicle involved in a hit-and-run accident, in one aspect, may comprise a damage signature generator operable to execute on a processor and further operable to generate a damage signature associated with a first vehicle that is left behind with collision damage in a hit-and-run accident. The system may also comprise a reverse event signature generator operable to execute on the processor and further operable to generate a reverse event signature that indicates a position of impact and severity of damage associated with a second vehicle involved in the hit-and-run accident that fled a scene of the hit-and-run accident, the reverse event signature generator generating the reverse event signature based on reverse engineering the damage signature associated with the first vehicle.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 illustrates a schematic diagram for generating a reverse event signature in one embodiment of the present disclosure.

FIG. 2 is a flow diagram illustrating a method of the present disclosure in one embodiment.

FIG. 3 illustrates a schematic of an example computer or processing system that may implement a reverse event signature generator system in one embodiment of the present disclosure.

### DETAILED DESCRIPTION

The present disclosure in aspect provides that a vehicle could be installed with a number of sensors that measure the degree of damage. The present disclosure in one aspect provides an estimate regarding the location on the vehicle and the degree of damage to the other vehicle that caused a hit-and-run. For example, a reverse event signature that indicates the position of the impact and severity of the other vehicle may be provided. In one embodiment of the present disclosure, this information is automatically sent through wireless communications to a recipient, for example, to the nearest authority such as a police station, and/or automobile body shops, based on global positioning satellite (GPS) location or the like of the vehicle. In this way, at least some basic information may be generated and disseminated, of what to look for in order to identify the other vehicle (vehicle that fled) involved. In this way, information about the other vehicle (hit-and-run) that caused damage to the vehicle may be retrieved without using a video recorder. Of course, if the vehicle is equipped with a camera, one or more pictures of images may be transmitted also, for example, any pictures that may have been captured at the time of impact to help in identifying or locating that other vehicle.

In one embodiment of the present disclosure, a damage estimate is generated on the vehicle that one desires to locate, e.g., the hit-and-run vehicle. The damage estimate may be computed based on the assumption that both vehicles (the hit-and-run vehicle and the vehicle left behind) impacted in the accident are damaged. Such damage estimate in the present disclosure is referred to as reverse accident damage signature (RADS). The RADS may also comprise the location of the accident, for example, the GPS coordinates of the global accident zone damage, as determined by a GPS device. The global accident zone encompasses the square area of the union defined by the GPS location of the hit-and-run vehicle and the victim car. The additional information provides a square area with approximate locations of the car represented by two vectors. The direction and magnitude of speed help to further define RADS.

In one embodiment of the present disclosure, a reverse engineering process may be utilized for building the damage signature estimated to be present on this vehicle (one being located). The car that is left behind with damage (e.g., collision damage) need not have had occupants in it. Thus, a methodology of the present disclosure may be operable in situations in which a car was parked without passengers in it. The RADS so computed may aid in hit-and-run investigations.

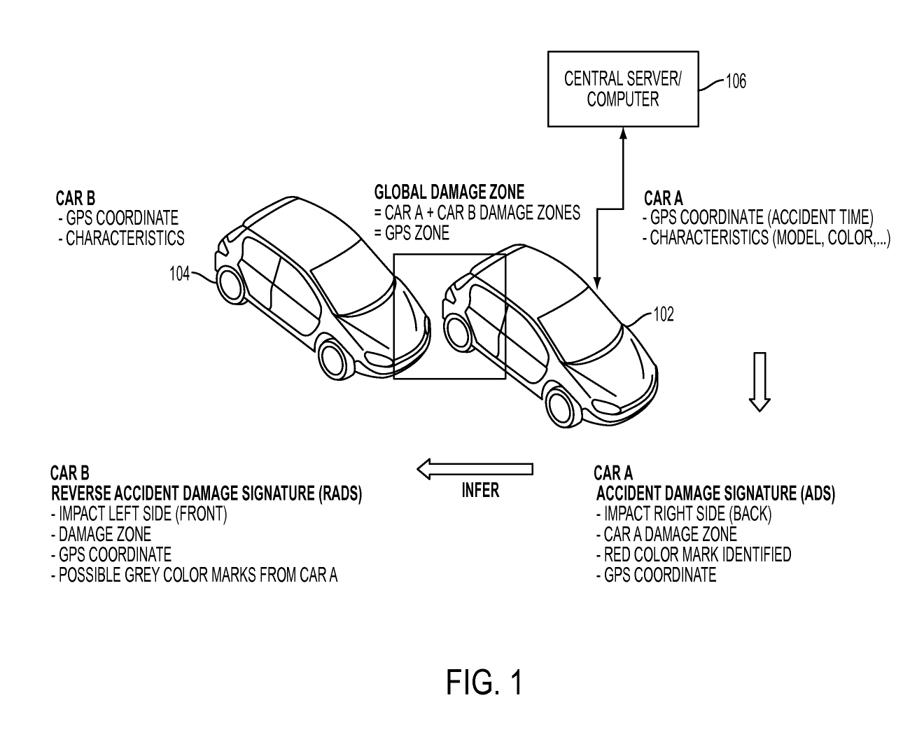

FIG. 1 illustrates a schematic diagram for generating a reverse event signature in one embodiment of the present disclosure. Car A 102 illustrates the car being damaged. Car B 104 illustrates the car causing the damage, e.g., that hits or collides with Car A. The following scenario may occur. Car B 104 causes an accident with Car A 102. Car A 102 is hit by Car B 104, e.g., at the back right rear side. Car A 102 has a system that “senses” what happened. Examples of such senor may include, but are not limited to, one or more of accelerometer, gyroscope, crankshaft position sensor, curb feeler that warns driver of curbs, engine coolant temperature sensor that measures the engine temperature, hall effect sensor that times the speed of wheels and shafts, oxygen sensor that monitors the amount of oxygen in the exhaust, mass flow sensor that tell the engine control unit (ECU) the mass of air entering the engine, and/or others. For example, Car A 102 may be equipped with sensors that are activated and that record a set of damage parameters such as the physical impact, penetration angle, GPS coordinates, accident time, characteristics of Car A 102 (such as the make, model, color), and/or other information. This information (damage parameters) may be used to infer the damage on Car B 104 (RADS of Car B).

In one embodiment of the present disclosure, the collected information (damage parameters) may be sent to a central server 106 for computing or generating the reverse accident damage signature. The central server 106, based on the collected information, may evaluate material deformation of car A 102, estimate the power impact (penetration) for Car A 102, estimate the power impact (penetration) for Car B 104 as the reverse operation, construct the Car B damage signature based on the physical damage estimate based on the point of impact and the possible location of the damage inferred from GPS coordinates. Car B's characteristics may be inferred also, for example, if Car A 102 had a color paint rubbed off from Car B, Car B's color may be inferred.

In another embodiment of the present disclosure, the RADS may be generated locally by software or like component installed in Car A 102.

In determining or computing the RADS, the different factors may be considered. For example, in a parking lot, the hit could be caused by someone moving backward; this context may be taken into account. As another example, Car A characteristics such as its color and model may be taken into account. For instance, assume Car B is much more fragile than Car A (or vice versa), than Car B will have probably more damage. As another example, one or more rules may be applied based on or considering the angle of impact.

In one aspect, a driver of the car (left behind) may record an after the damage video and send it to a central server 106. The appearance of the car may be recorded, for example, to identify painting damage, length and shape of visual change, and other appearances. Such visual aspect may help to infer that painting Car A came off and may have gotten on to the other Car B as a visual trace. Yet in another aspect, there could be specific signatures associated to motorcycle, trucks, and other types of vehicles. For instance trucks have different size (height). Damages need not be restricted to external ones as car's interior may also be impacted.

An accident report (e.g., that includes the damage signature of Car A and/or the generated RADS of Car B) may be automatically sent to a law enforcement agency. Damage signature of Car A and/or the generated RADS of Car B may also be sent to auto repair shops.

The central server 106 may include a database of reverse signatures. For example, a damage signature has a corresponding reverse one (or opposite one). The database of reverse signature, for example, contains historical accidents. The aggregate information from the current accident may be used in conjunction with the database information about the previous accidents in probabilistic reasoning for the reverse signature of the current. For example, the probability of RADS 1 may be determined given global area or proximity of the collision, damage information from the victim, and information from various sensors. Based on the damage signature and its reverse signature, the central server 106 may construct a Global Damage Zone, which comprises of the Car A's damage zone and Car B's damage zone. Damage zone here refers to the area (e.g., square meter area) that is unioned from position Car A and Car B. The central server 106 may retrieve all pictures and videos in this spatial area. The pictures might be from roadside cameras, cell phones, sounds from microphones, weight sensors on roads that are acquired, e.g., several minutes before and after the accident. For instance, the central server 106 may request those pictures and videos from a file management system that a municipality may maintain. The central server 106 may also request from one or more operators (such as mobile devices, global positioning system (GPS) navigators) whether there was a car located at the same GPS coordinates as the Car A accident damage zone. Based on the information, the central server 106 may employ a signature matching algorithm to determine a reverse signature. For example, matching algorithms can be any measure between feature vectors such as root-mean-square error (RMSE). Other techniques such as decision trees, logistic regression, non-linear regression, interpolation/extrapolation, neural networks, support vector machines (SVM's), a form of machine learning, and/or others can be ensembled together. The pictures and videos may be used in time series forecasting to predict what had happened and ultimately the RAD. Feature extraction modules such as haar, harris, blob, convolutions, and others may be utilized.

In one embodiment of the present disclosure, in order to infer the location or direction of the impact or the collision (e.g., the cars collided at what angle, e.g., perpendicular, left side in the front), the road profile (e.g., retrieved from maps at the GPS collision coordinates or damage zone) weight may be used for the evaluation. For example, information about the road and/or area where the hit-and-run accident occurred may be used to determine or infer the damage location of the car that fled (e.g., Car B in FIG. 1). The road profile, for example, may provide information as to whether the road is one way street, two way street, the number of lanes on the road, and other geographic information. Based on such information, a road profile weight may be assigned and used in inferring. For example, if a road is one way, then it is less likely that there would be a head on collision. This type of information helps to prune possible hypothesis about RADS. In one aspect, given the GPS coordinates, multimedia content or any other signals can be retrieved from the correct scene of the crime.

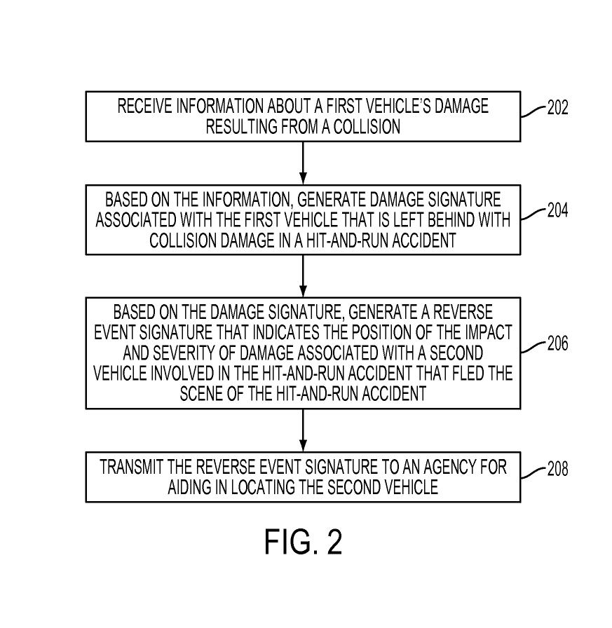

FIG. 2 is a flow diagram illustrating a method of identifying and/or locating a vehicle in a hit-and-run in one embodiment of the present disclosure. At 202, information about a first vehicle's damage resulting from a collision is received. The first vehicle here refers to the vehicle that is left behind with collision damage in a hit-and-run accident. As discussed above, this information may include the damage present on the first vehicle and the location of the damage present on the first vehicle. The information may also include global positioning system coordinates for a damage zone associated with hit-and-run accident. The damage zone may be the area or vicinity thereof, where the damage to the vehicles may have occurred. The damage present on the first vehicle may include material deformation associated with the first vehicle or power of impact of the first vehicle or combinations thereof. In addition, information associated with the first vehicle such as the color, the make and the model, may be received for evaluating the damage.

At 204, a damage signature (also referred to above as an accident damage signature) associated with the first vehicle that is left behind with collision damage in a hit-and-run accident is generated based on the information. The first vehicle is also referred to as a damaged vehicle. At 206, a reverse event signature (also referred to as a reverse accident damage signature) is generated that indicates the position of the impact and severity of damage associated with a second vehicle involved in the hit-and-run accident that fled the scene of the hit-and-run accident. The reverse event signature may be generated by reverse engineering the damage signature associated with the first vehicle. The reverse event signature may include the location of the collision impact associated with the second vehicle, material deformation associated with the second vehicle, or power of impact of the second vehicle or combinations thereof. This reverse event signature can be generated, for example, even without needing identifying information associated with the second vehicle or in the absence of identifying information of the second vehicle (although if available would further help in identifying the second vehicle), for instance, only based on the damage information of the first vehicle and any other information such as the road profile of the accident zone.

At 208, the reverse event signature may be transmitted to an agency, for example, one or more law enforcement authorities, an automobile body shop or garage or the like. The transmission may be via a wireless medium.

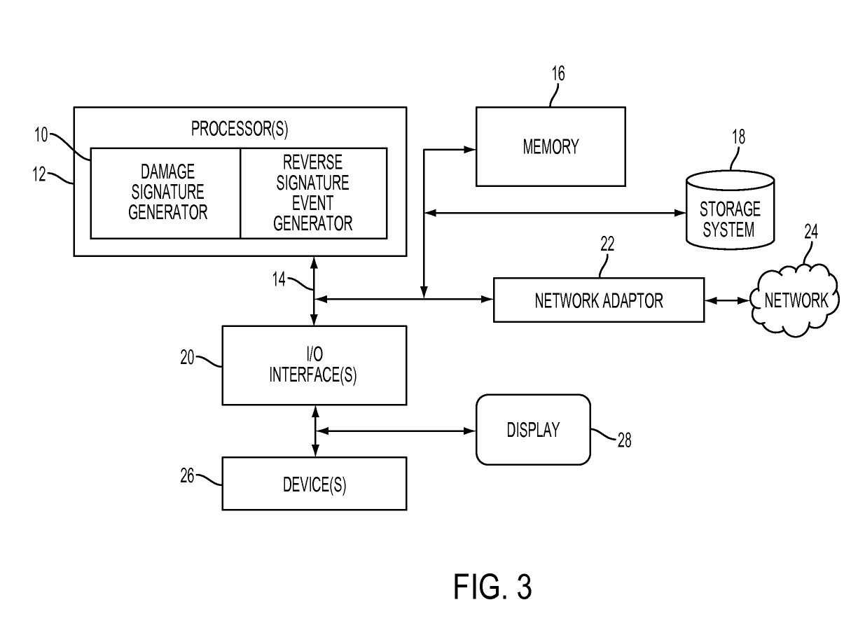

FIG. 3 illustrates a schematic of an example computer or processing system that may implement a reverse event signature system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 3 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a signature generator module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A system for identifying a vehicle involved in a hit-and-run accident, comprising:
a processor;
a damage signature generator operable to execute on the processor and further operable to generate a damage signature associated with a first vehicle that is left behind with collision damage in a hit-and-run accident; and
a reverse event signature generator operable to execute on the processor and further operable to generate a reverse event signature that indicates a position of impact and severity of damage associated with a second vehicle involved in the hit-and-run accident that fled a scene of the hit-and-run accident, the reverse event signature generator generating the reverse event signature based on reverse engineering the damage signature associated with the first vehicle.

2. The system of claim 1, wherein the reverse event signature is transmitted to one or more agencies.

3. The system of claim 2, wherein the one or more agencies comprises a law enforcement authority, or an automobile body shop, or combinations thereof.

4. The system of claim 2, wherein the generated reverse event signature is transmitted wirelessly.

5. The system of claim 1, wherein the damage signature associated with the first vehicle is generated based on information received from the first vehicle, the information comprising at least damage present on the first vehicle, location of the damage present on the first vehicle and global positioning system coordinates for a damage zone associated with hit-and-run accident.

6. The system of claim 5, wherein the damage present on the first vehicle comprises material deformation associated with the first vehicle or power of impact of the first vehicle or one or more combinations thereof.

7. The system of claim 1, wherein the reverse event signature comprises collision impact location associated with the second vehicle, material deformation associated with the second vehicle, or power of impact of the second vehicle or one or more combinations thereof.

8. The system of claim 1, wherein the reverse event signature is generated in the absence of identifying information associated with the second vehicle.

9. A computer readable storage medium storing a program of instructions executable by a machine to perform a method of identifying a vehicle involved in a hit-and-run accident, the method comprising:
generating a damage signature associated with a first vehicle that is left behind with collision damage in a hit-and-run accident; and
generating a reverse event signature that indicates a position of impact and severity of damage associated with a second vehicle involved in the hit-and-run accident that fled a scene of the hit-and-run accident, the generating of the reverse event signature based on reverse engineering the damage signature associated with the first vehicle.

10. The computer readable storage medium of claim 9, wherein the damage signature associated with the first vehicle is generated based on information received from the first vehicle, the information comprising at least damage present on the first vehicle, location of the damage present on the first vehicle and global positioning system coordinates for a damage zone associated with hit-and-run accident.

11. The computer readable storage medium of claim 10, wherein the damage present on the first vehicle comprises material deformation associated with the first vehicle or power of impact of the first vehicle or one or more combinations thereof.

12. The computer readable storage medium of claim 9, wherein the reverse event signature comprises collision impact location associated with the second vehicle, material deformation associated with the second vehicle, or power of impact of the second vehicle or one or more combinations thereof.
